(19) United States
(12) Patent Application Publication
(10) Pub. No.: US 2019/0084262 A1
(43) Pub. Date: Mar. 21, 2019

(54) Punch Retainer Cover

(71) Applicant: Dayton Lamina Corporation, Dayton, OH (US)

(72) Inventors: Lawrence W. Johnson, Taylor, MI (US); Brian S. Marsh, Miamisburg, OH (US); Kevin John Latouf, Windsor (CA)

(21) Appl. No.: 15/708,840

(22) Filed: Sep. 19, 2017

(51) Int. Cl. B30B 15/00

(52) U.S. Cl. CPC B30B 15/0082; B30B 11/02

(57) ABSTRACT

A punch retainer cover comprises a pliable casing configured as a jacket for a punch retainer having a defined physical envelope. The pliable casing has a substantially planar top side and a skirt extending downward from a perimeter of the top side of the pliable casing. The top side and skirt define an open interior volume shaped to match the defined physical envelope of the punch retainer and sized for stretchably jacketing the punch retainer. Further, the punch retainer cover includes an aperture or slot in the top side that, when the punch retainer cover is mounted on the punch retainer, aligns with a punch receptacle of the punch retainer. The aperture or slot is sized for stretchably surrounding a punch mounted in the punch receptacle and projecting upwardly through the aperture or slot.

### TECHNICAL FIELD

The present invention relates to punch presses and, particularly, to punch retainers used with punch presses.

### BACKGROUND

FIG. 1 illustrates a punch retainer 10 configured to retain a punch 12, for use in a punch press apparatus—not shown. The body of the punch retainer 10 includes a punch receptacle 14 for removable retention of the punch 12 and further includes mounting features 16, which may comprise countersunk holes for securely bolting the punch retainer 10 to the punch press apparatus. Other possible features include a quick release feature 18, which allows an operator to insert a screwdriver or other tool, to release the punch 12 from the punch receptacle 14.

Punch operations often produce particulate matter or other fine waste product and gravity causes the waste product to accumulate on and in the punch retainer 10. Excess accumulation interferes with various aspects of use. For example, excess accumulation of waste product in the quick release feature 18 interferes with its actuation. Similar problems arise concerning the mounting features 16. Restoring access to the mounting features 16 and quick release feature 18 requires cleaning, necessitating undesirable work stoppage and maintenance hassles.

### SUMMARY

A punch retainer cover comprises a pliable casing configured as a jacket for a punch retainer having a defined physical envelope. The pliable casing has a substantially planar top side and a skirt extending downward from a perimeter of the top side of the pliable casing. The top side and skirt define an open interior volume shaped to match the defined physical envelope of the punch retainer and sized for stretchably jacketing the punch retainer. Further, the punch retainer cover includes an aperture or slot in the top side that, when the punch retainer cover is mounted on the punch retainer, aligns with a punch receptacle of the punch retainer. The aperture or slot is sized for stretchably surrounding a punch mounted in the punch receptacle and projecting upwardly through the aperture or slot.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a perspective view of a known punch retainer with a punch mounted therein.

FIG. 2 is a perspective view of known punch retainer jacketed by an example embodiment of a punch retainer cover.

FIG. 3 is a perspective view of another example embodiment of a punch retainer cover.

FIG. 4 is another perspective view of the punch retainer cover of FIG. 3, illustrating a bottom-side interior volume shaped to match a punch retainer and sized for stretchably jacketing the punch retainer.

### DETAILED DESCRIPTION

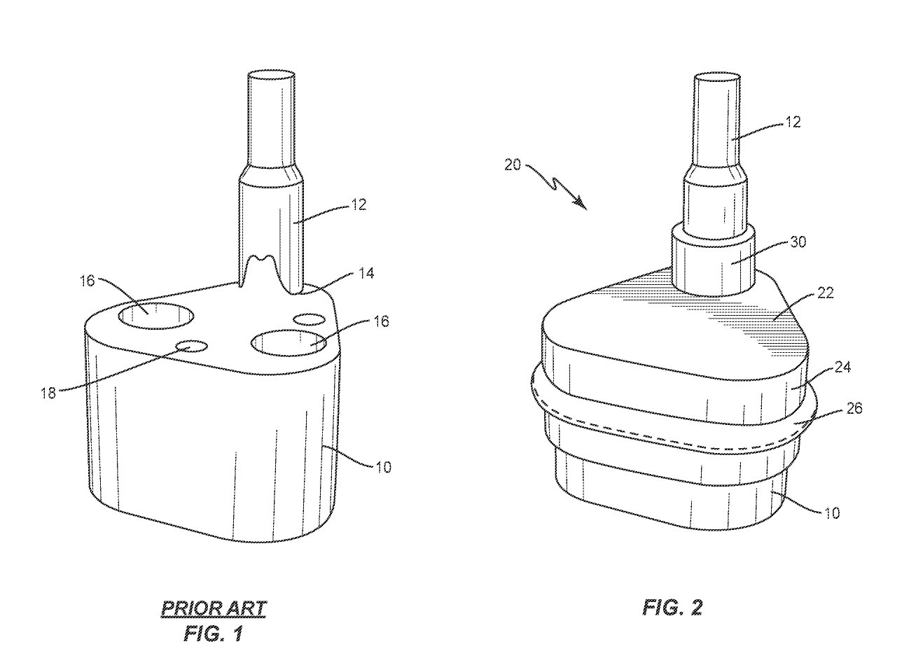

FIG. 2 illustrates a punch retainer cover 20 according to an example embodiment. Without suggesting limitations on the shape and the size, the form factor and dimensions of the illustrated punch retainer cover 20 correspond with the example punch retainer 10 and punch 12 shown in FIG. 1. As the punch retainer 10 depicted in FIG. 1 has a rounded triangular wedge shape, the punch retainer cover 20 in FIG. 1 forms an interior volume having a corresponding shape, with the understanding that the punch retainer cover 20 is sized for stretchably fitting over and covering the punch retainer 10.

Broadly, the form factor and dimensions of the punch retainer cover 20 in any particular application correspond to the form factor and dimensions of the punch retainer targeted by the application. Correspondingly, the punch retainer cover 20 comprises a pliable casing configured as a jacket for the targeted punch retainer 10, which has a defined physical envelope. According to example details, the pliable casing has a substantially planar top side 22 and a skirt 24 extending downward from a perimeter of the top side 22 of the pliable casing. The top side covers the substantially planar upper surface of the punch retainer 10 and the skirt envelopes and grips the exterior side surfaces of the punch retainer 10.

Together, the top side 22 and skirt 24 define an open interior volume—detailed in a later illustration—that is shaped to match the defined physical envelope of the punch retainer 10 and sized for stretchably jacketing the punch retainer 10. Further features of the punch retainer cover 20 in at least some embodiments include one or more ridges 26 that serve as pinch points that facilitate gripping the punch retainer cover 20. In FIG. 2, the skirt 24 includes a continuous ridge 26 that facilitates gripping the punch retainer cover 20 for seating over the punch retainer 10 or removing the punch retainer cover 20 from the punch retainer 10. Providing enhanced and durable points at which an operator may pinch—with fingers, pliers, etc.—the pliable casing of the punch retainer cover 20 allows for tight fitment of the punch retainer cover 20 with respect to the punch retainer 10 without causing undue inconvenience when installing or removing the punch retainer cover 20.

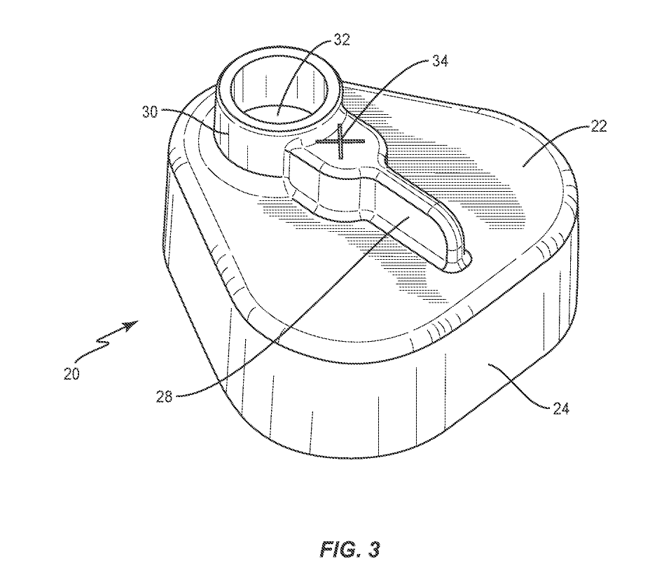

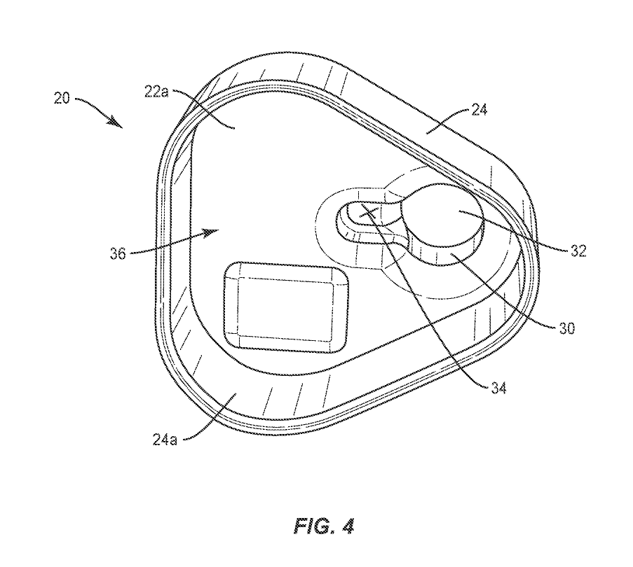

The perspective view offered in FIG. 3 for another embodiment of the punch retainer cover 20 illustrates a variation of the gripping-ridge mechanism, wherein the top side 22 of the punch retainer cover 20 includes an upwardly projecting tab 28. As with the ridge 26, forming the tab 28 involves, in an example embodiment, molding the pliable casing of the punch retainer cover 20 to provide a thickened projection or web, suitable for pulling without tearing or separating. Broadly, the pliable casing comprising the punch retainer cover 20 may include one or more tabs 28, e.g., extending upward from the top side 22 of the pliable casing or extending horizontally outward from the skirt 24. Either way, the tab(s) 28 provide one or more respective pinch points to aid removal of the punch retainer cover 20 from the punch retainer 10. Positioning a tab 28 substantially at the perimeter of the top side 22 provides certain mechanical advantages for removal of the punch retainer cover 20 from the punch retainer 10.

Further example features visible in FIG. 3 include an aperture or slot 30 formed in the top side 22 of the punch retainer cover 20. When the punch retainer cover 20 is mounted on the punch retainer 10, the aperture or slot 30 aligns with a punch receptacle 14 of the punch retainer 10 and is sized for stretchably surrounding a punch 12 mounted in the punch receptacle 14 and projecting upwardly through an opening 32 defined by the aperture or slot 30.

In at least one embodiment of the punch retainer cover 20, the top side 22 of the pliable casing includes a further aperture or slot 34. When the punch retainer cover 20 is mounted on the punch retainer 10, the further aperture or slot 34 vertically aligns with a quick release feature 18 of the punch retainer 10, thereby providing access to the quick release feature 18. Hence, an operator can actuate the quick release feature 18 of the punch retainer 10 for removal of a punch 12 seated in the punch receptacle 14 of the punch retainer 10, without having to remove the punch retainer cover 20. Forming this access feature as a slot—e.g., a cross-cut slot—offers advantages as compared to an open aperture, concerning resisting the infiltration of particulate matter.

The composition of the punch retainer cover 20 at least broadly matches its contemplated usage and includes at least a suitable degree of elasticity for the contemplated jacketed fitment of the punch retainer cover 20 over the targeted punch retainer 10. At least some embodiments, however, involve more detailed formulations targeting one or more operating requirements, such as temperature range, abrasion resistance, and chemical resistance. In at least one such embodiment, the pliable casing comprising the punch retainer cover 20 is a urethane rubber. In another embodiment, the pliable casing is a thermoplastic elastomer.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A punch retainer cover comprising a pliable casing configured as a jacket for a punch retainer having a defined physical envelope, the punch retainer cover comprising:
a pliable casing having a substantially planar top side and a skirt extending downward from a perimeter of the top side of the pliable casing;
said top side and skirt defining an open interior volume shaped to match the defined physical envelope of the punch retainer and sized for stretchably jacketing the punch retainer; and
said punch retainer cover including an aperture or slot in the top side that, when the punch retainer cover is mounted on the punch retainer, aligns with a punch receptacle of the punch retainer and sized for stretchably surrounding a punch mounted in the punch receptacle and projecting upwardly through the aperture or slot.

2. The punch retainer cover of claim 1, further comprising one or more tabs extending upward from the top side of the pliable casing, to provide one or more respective pinch points to aid removal of the punch retainer cover from the punch retainer.

3. The punch retainer cover of claim 2, wherein the one or more tabs comprise one tab positioned substantially at the perimeter of the top side.

4. The punch retainer cover of claim 1, further comprising one or more ridges projecting outward from the skirt of the pliable casing, each ridge providing a pinch point to aid removal of the punch retainer cover from the punch retainer.

5. The punch retainer cover of claim 1, wherein the pliable casing comprises a urethane rubber.

6. The punch retainer cover of claim 1, wherein the pliable casing comprises a thermoplastic elastomer.

7. The punch retainer cover of claim 1, wherein the top side of the pliable casing includes a further aperture or slot that, when the punch retainer cover is mounted on the punch retainer, vertically aligns with a quick disconnect feature of the punch retainer, thereby providing access to the quick disconnect feature.
